(19) United States
(12) Patent Application Publication
(10) Pub. No.: US 2025/0192835 A1
(43) Pub. Date: Jun. 12, 2025

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Naoya Shibaike, Chiyoda-ku, Tokyo (JP); Satoshi Nagata, Chiyoda-ku, Tokyo (JP); Jing Wang, Haidian District, Beijing (CN); Weiqi Sun, Haidian District, Beijing (CN); Lan Chen, Haidian District, Beijing (CN)

(73) Assignee: NTT DOCOMO, INC., Tokyo (JP)

(21) Appl. No.: 18/846,044

(22) PCT Filed: Mar. 16, 2022
(86) PCT No.: PCT/JP2022/011928

§ 371 Date: Sep. 11, 2024

(51) Int. Cl. H04B 7/06; H04L 5/00; H04W 8/22; H04W 72/11

(52) U.S. Cl. CPC H04B 7/0602; H04L 5/005; H04W 8/22; H04W 72/11

(57) ABSTRACT

A terminal according to one aspect of the present disclosure includes a receiving section that receives a higher layer parameter indicating antenna switching as a usage for a sounding reference signal (SRS) resource set, and a control section that applies six or more SRS ports and six or more antenna ports according to terminal capability information related to the antenna switching. According to one aspect of the present disclosure, SRS transmission can be appropriately controlled when antenna switching is configured as a usage for an SRS.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In Rel-15 NR, there are various usages for a sounding reference signal (SRS) transmitted by a terminal (user terminal, User Equipment (UE)). For future radio communication systems (for example, Rel. 17), enhancement of the SRS has been under study.

In Rel-15 NR, antenna switching can be configured as a usage for the SRS. However, a configuration related to the SRS when antenna switching is configured as the usage for the SRS has not been fully studied. In this case, it is difficult for the UE to appropriately perform SRS transmission, and thus communication throughput may be deteriorated.

In view of this, the present disclosure has one object to provide a terminal, a radio communication method, and a base station that can appropriately control SRS transmission when antenna switching is configured as a usage for an SRS.

### Solution to Problem

A terminal according to one aspect of the present disclosure includes a receiving section that receives a higher layer parameter indicating antenna switching as a usage for a sounding reference signal (SRS) resource set, and a control section that applies six or more SRS ports and six or more antenna ports according to terminal capability information related to the antenna switching.

### Advantageous Effects of Invention

According to one aspect of the present disclosure, SRS transmission can be appropriately controlled when antenna switching is configured as a usage for an SRS.

### BRIEF DESCRIPTION OF DRAWINGS

FIG. 1 is a diagram to show a correspondence example between SRS resources and antenna ports in a case of 1T2R in Rel. 16.

FIG. 2 is a diagram to show a correspondence example between SRS resources and antenna ports in a case of 2T4R in Rel. 16.

FIG. 3 is a diagram to show a first example of a correspondence between SRS resources and antenna ports in a case of 1T4R in Rel. 16.

FIG. 4 is a diagram to show a second example of a correspondence between SRS resources and antenna ports in the case of 1T4R in Rel. 16.

FIG. 5 is a diagram to show a third example of a correspondence between SRS resources and antenna ports in the case of 1T4R in Rel. 16.

FIG. 6 is a diagram to show a first example of a correspondence between SRS resources and antenna ports in a case of 1T6R in Rel. 16.

FIG. 7 is a diagram to show a second example of a correspondence between SRS resources and antenna ports in the case of 1T6R in Rel. 16.

FIG. 8 is a diagram to show a first example of a correspondence between SRS resources and antenna ports in a case of 1T8R in Rel. 16.

FIG. 9 is a diagram to show the first example of a correspondence between SRS resources and antenna ports in a case of 1T8R in Rel. 16.

FIG. 10 is a diagram to show a correspondence example between SRS resources and antenna ports in a case of 2T6R in Rel. 16.

FIG. 11 is a diagram to show a correspondence example between SRS resources and antenna ports in a case of 2T8R in Rel. 16.

FIG. 12 is a diagram to show a correspondence example between SRS resources and antenna ports in a case of 4T8R in Rel. 16.

FIG. 13 is a diagram to show a guard period between two SRS resources when a usage is antenna switching in Rel. 15 and Rel. 16.

FIG. 14A to FIG. 14C are diagrams to show examples of SRS transmission in 1T2R.

FIG. 15A to FIG. 15C are diagrams to show examples of SRS transmission in 2T4R.

FIG. 16 is a diagram to show an example of option 1 of Embodiment 1-1.

FIG. 17 is a diagram to show an example of option 2 of Embodiment 1-1.

FIG. 18 is a diagram to show an example of option 3 of Embodiment 1-1.

FIG. 19 is a diagram to show an example of option 5 of Embodiment 1-1.

FIG. 20 is a diagram to show an example of option 6 of Embodiment 1-1.

FIG. 21 is a diagram to show an example of option 1 and option A of Embodiment 1-2.

FIG. 22 is a diagram to show a first example of option 2 and option B of Embodiment 1-2.

FIG. 23 is a diagram to show a second example of option 2 and option B of Embodiment 1-2.

FIG. 24 is a diagram to show an example of option 6 and option A of Embodiment 1-2.

FIG. 25 is a diagram to show an example of a schematic structure of a radio communication system according to one embodiment.

FIG. 26 is a diagram to show an example of a structure of a base station according to one embodiment.

FIG. 27 is a diagram to show an example of a structure of a user terminal according to one embodiment.

FIG. 28 is a diagram to show an example of a hardware structure of the base station and the user terminal according to one embodiment.

FIG. 29 is a diagram to show an example of a vehicle according to one embodiment.

### DESCRIPTION OF EMBODIMENTS

### SRS

In Rel-15 NR, there are various usages for a sounding reference signal (SRS). The SRS in NR is used not only for uplink (UL) CSI measurement that is used in existing LTE (LTE Rel. 8 to Rel. 14) as well, but is also used for downlink (DL) CSI measurement, beam management, and the like. The SRS may be used for positioning.

A terminal (user terminal, User Equipment (UE)) may be configured with one or a plurality of SRS resources. Each SRS resource may be identified with an SRS resource index (SRI).

Each SRS resource may include one or a plurality of SRS ports (may correspond to one or a plurality of SRS ports). For example, the number of ports for each SRS may be 1, 2, 4, or the like.

The UE may be configured with one or a plurality of SRS resource sets. One SRS resource set may be related to a given number of SRS resources. The UE may use a common higher layer parameter for the SRS resources included in one SRS resource set. Note that the resource set in the present disclosure may be interpreted as a set, a resource group, a group, or the like.

Information related to the SRS resource or the resource set may be configured for the UE, using higher layer signaling, physical layer signaling (for example, downlink control information (DCI)), or a combination of these.

SRS configuration information (for example, an RRC information element “SRS-Config”) may include SRS resource set configuration information, SRS resource configuration information, and the like.

The SRS resource set configuration information (for example, an RRC parameter “SRS-ResourceSet”) may include pieces of information of an SRS resource set ID (Identifier) (SRS-ResourceSetId), a list of SRS resource IDs (SRS-ResourceId) used in the resource set, an SRS resource type, and a usage for the SRS, and the like. Note that the SRS resource ID may be referred to as an SRS Resource ID (SRI).

Here, the SRS resource type may indicate any one of a periodic SRS (P-SRS), a semi-persistent SRS (SP-SRS), and an aperiodic SRS (A-SRS). Note that the UE may transmit the P-SRS and the SP-SRS periodically (or periodically after activation). The UE may transmit the A-SRS, based on an SRS request on DCI.

The usage for the SRS (RRC parameter “usage”) may be, for example, beam management (beamManagement), a codebook, a non-codebook (nonCodebook), antenna switching (antennaSwitching), or the like. For example, the SRS with the usage of the codebook or the non-codebook may be used for determination of a precoder for codebook based or non-codebook based uplink shared channel (Physical Uplink Shared Channel (PUSCH)) transmission based on the SRI.

For the SRS with the usage of beam management, it may be assumed that only one SRS resource in each SRS resource set can be transmitted in a certain time instant. Note that, when the plurality of SRS resources respectively belong to different SRS resource sets, these SRS resources may be simultaneously transmitted.

The SRS resource configuration information (for example, an RRC parameter “SRS-Resource”) may include information related to an SRS resource ID (SRS-ResourceId), the number of SRS ports, an SRS port number, a transmission comb, SRS resource mapping (for example, a time and/or frequency resource position, a resource offset, periodicity of the resources, the number of repetitions, the number of SRS symbols, an SRS bandwidth, or the like), hopping, an SRS resource type, a sequence ID, spatial relation, and the like.

The UE may transmit the SRS in as many adjacent symbols as the number of SRS symbols within the last six symbols in one slot. Note that the number of SRS symbols may be 1, 2, 4, or the like. The UE may start SRS transmission from a symbol that is an offset before the last symbol in one slot. The offset may be 0 to 5 symbols given by an RRC parameter “startPosition”.

Note that the number of repetitions (RRC parameter “repetitionFactor”) may be a value equal to or less than the number of SRS symbols. When the number of repetitions is 2 or greater, the SRS of the number of SRS symbols may be repeatedly transmitted over a plurality of slots.

The UE may switch BWPs (Bandwidth Parts) for transmitting the SRS for each slot, or may switch antennas. The UE may apply at least one of intra-slot hopping and inter-slot hopping to SRS transmission.

### SRS Antenna Switching

In Rel-15 NR, as described above, antenna switching (which may be referred to as antenna port switching) can be configured as a usage for the SRS. SRS antenna switching may be used to perform downlink CSI acquisition (acquisition) in a time division duplex (TDD) band, using an uplink SRS, for example.

For example, for the UE having a capability that the number of antenna ports available for transmission is less than the number of antenna ports available for reception, UL SRS measurement may be used in order to determine a DL precoder.

Note that the UE may report, to a network, UE capability information (for example, an RRC parameter “supportedSRS-TxPortSwitch”) indicating a transmission port switching pattern of the supported SRS. The pattern may be expressed in a format of “txry”, such as “t1r2” and “t2r4”, for example, and this may mean that SRS transmission can be performed using x antenna ports out of a total of y antennas (which may be expressed as xTyR). Here, y may correspond to all of or a subset of receive antennas of the UE.

For example, for DL CSI acquisition, the UE of 2T4R (2 transmission ports, 4 reception ports) may include two SRS resources each including two ports, and may be configured with the SRS resource set having the usage of antenna switching.

Note that, when x and y in “txty” have the same value, it may be expressed as xT=xR (for example, 4T=4R).

The UE may assume that starting symbols of the SRS resources in the SRS resource set having the usage of antenna switching are different from each other. The UE may assume that there is a guard period between the SRS resources in the same SRS resource set.

The guard period may be referred to as a non-transmission period, an SRS switching period, a port switching period, or the like. The UE may assume no transmission of any signal (for example, any other signal) in the guard period in the slot in which the PUSCH is transmitted.

Using the guard period, the UE may turn on (which may be expressed as enable, start, or the like) the antenna port(s) to be used in the next SRS transmission.

The length of the guard period between the SRS resources may be a minimum guard period Y (Y=1 or 2 symbols) or more between the SRS resources, which is described in Table 6.2.1.2-1 in 3GPP TS 38.214. For example, Y=1 (when subcarrier spacing (SCS)=15, 30, 60 KHz), Y=2 (when SCS=120 kHz), or the like may be employed.

The UE in Rel-15/16 NR expects that the same number of SRS ports is configured for all of the SRS resources in the SRS resource set having the usage of antenna switching.

The UE in Rel-15/16 NR that has reported a capability of 1T1R, 2T4R, and 1T4R does not expect that more than one SRS resource set is configured or triggered in the same slot.

The UE in Rel-15/16 NR that has reported a capability of 1T=1R, 2T=2R, and 4T=4R does not expect that more than one SRS resource set is configured or triggered in the same symbol.

### Specific Examples of Configurations to Apply Antenna Switching in Rel. 15 and Rel. 16

For example, when the number of transmission ports of the UE is equal to or less than the number of reception ports, UE measurement for acquisition of DL CSI is used, and the usage for the SRS is configured to “antenna switching”. In Rel. 15 and Rel. 16, 1TIR, 2T2R, 4T4R, 1T2R, 2T4R, and 1T4R are supported. 1T2R, 2T4R, and 1T4R in Rel. 16 will be described below.

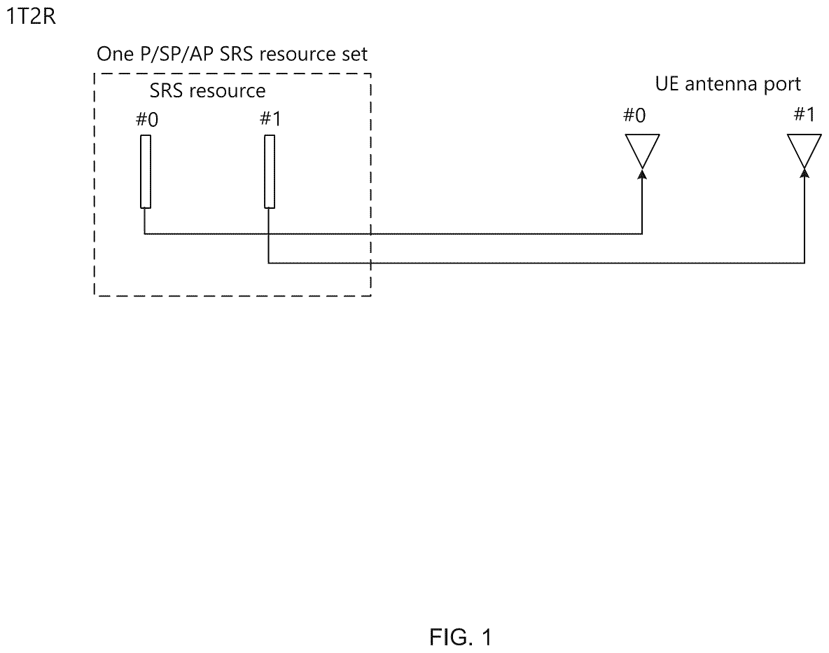

In a case of 1T2R, up to two SRS resource sets (P/SP/AP) having different time-domain operations are configured. In each resource set, two SRS resources with different symbols are included. In the example of FIG. 1, one SRS resource set includes two SRS resources, and each SRS resource includes a single SRS port. The SRS port of a first resource in the SRS resource set is associated with a UE antenna port different from the SRS port of a second resource in the same set.

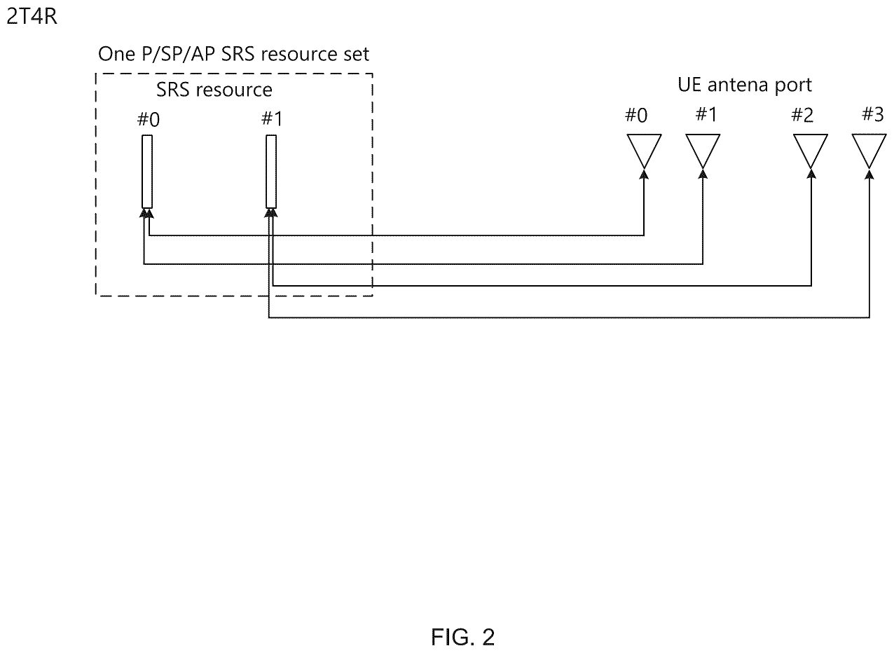

In a case of 2T4R, up to two SRS resource sets (P/SP/AP) having different time-domain operations are configured. In each resource set, two SRS resources with different symbols are included. In the example of FIG. 2, one SRS resource set includes two SRS resources, and each SRS resource includes two SRS ports (which may be referred to as a port pair). The SRS port pair of a first SRS resource is associated with a UE antenna port pair different from the SRS port pair of a second SRS resource. In FIG. 2, UE antenna ports #0 and #1 are a pair, and UE antenna ports #2 and #3 are a pair.

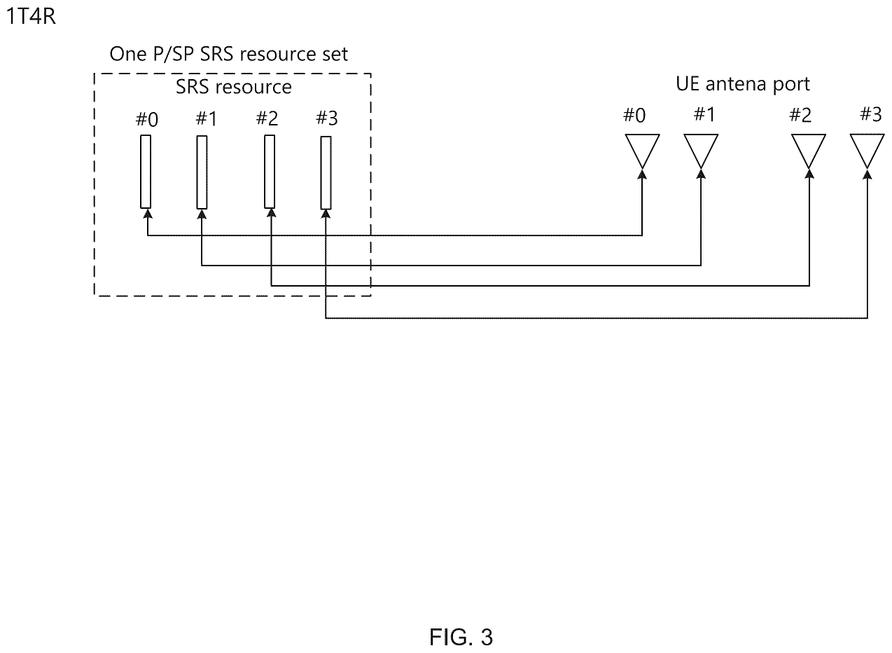

In a case of 1T4R, zero or one SRS resource set (P/SP) is configured. In each resource set, four SRS resources with different symbols are included. In the example of FIG. 3, one P/SP SRS resource set includes four SRS resources, and each SRS resource includes a single SRS port. The SRS ports of the SRS resources are associated with the UE antenna ports different from each other.

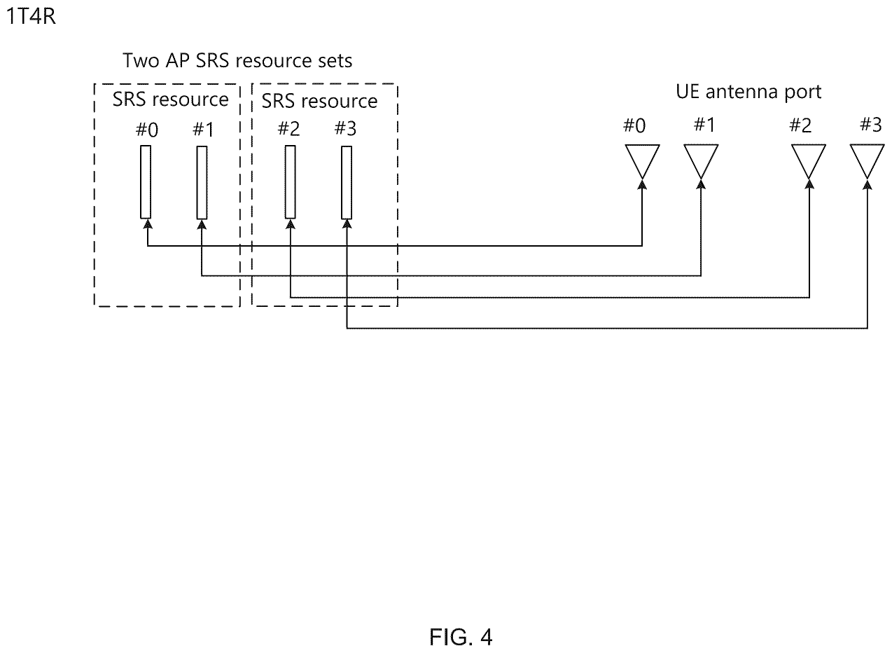

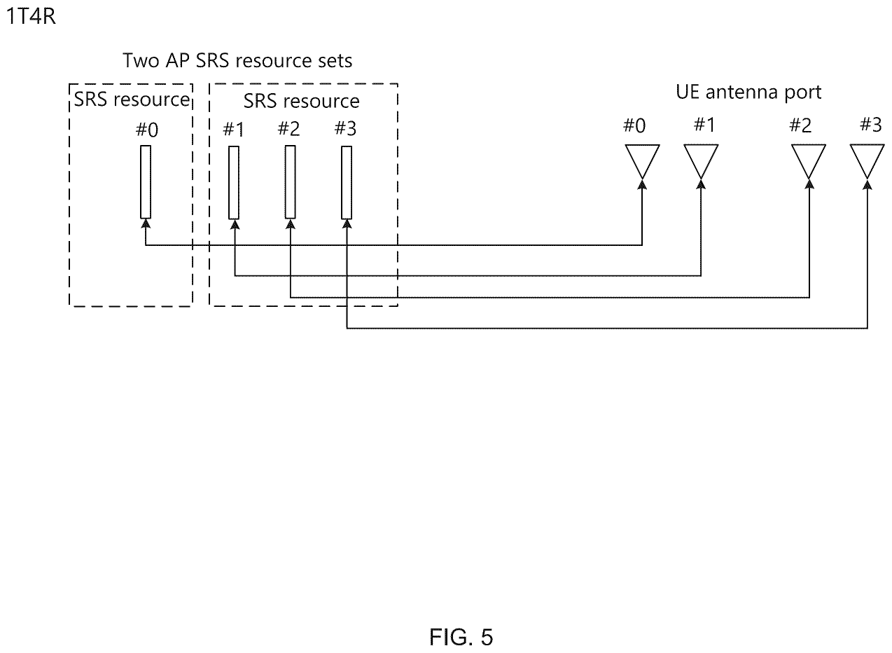

In a case of 1T4R, zero or two SRS resource sets (AP) are configured. In each resource set, a total of four SRS resources in different symbols in two slots are included. In the examples of FIG. 4 and FIG. 5, two AP SRS resource sets include a total of four SRS resources. Each SRS resource includes one SRS port. The SRS ports of the SRS resources of the two resource sets are associated with different UE antenna ports.

In the example of FIG. 4, the two resource sets each include two SRS resources. In the example of FIG. 5, one resource set in the two resource sets includes one SRS resource, and the other one resource set includes three SRS resources.

In cases of 1TIR, 2T2R, and 4T4R, up to two SRS resource sets are configured. Each resource set includes one SRS resource. The number of SRS ports of each SRS resource is any one of 1, 2, and 4.

### Specific Examples of New Configurations to Apply Antenna Switching

In Rel. 17, support of 1T6R, 1T8R, 2T6R, 2T8R, and 4T8R is further studied.

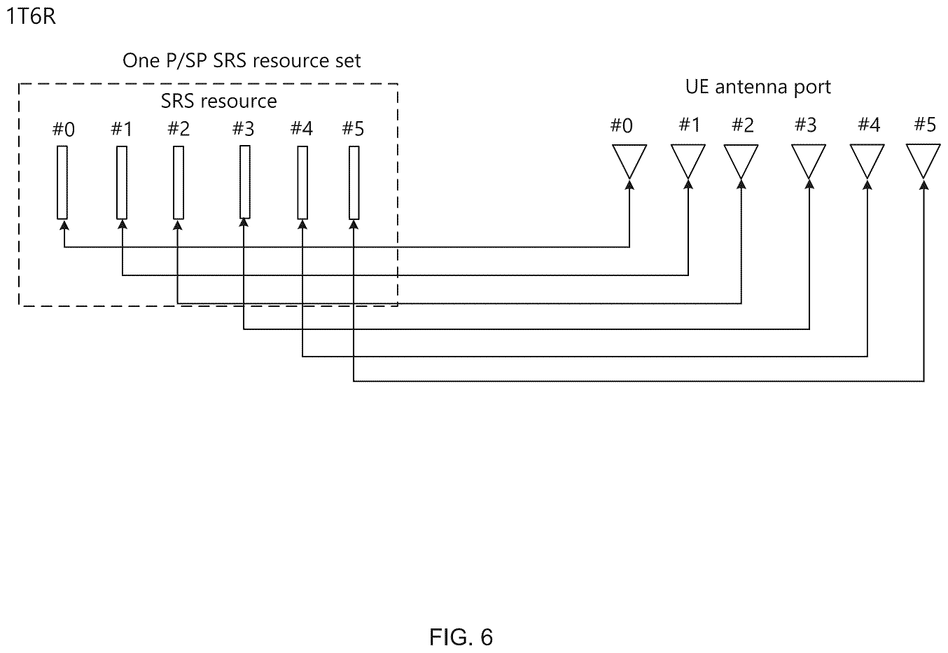

In a case of 1T6R, one P/SP SRS resource set may include six SRS resources, and each SRS resource may include a single SRS port (FIG. 6). The SRS ports of each SRS resource in the SRS resource set are associated with the UE antenna ports different from each other.

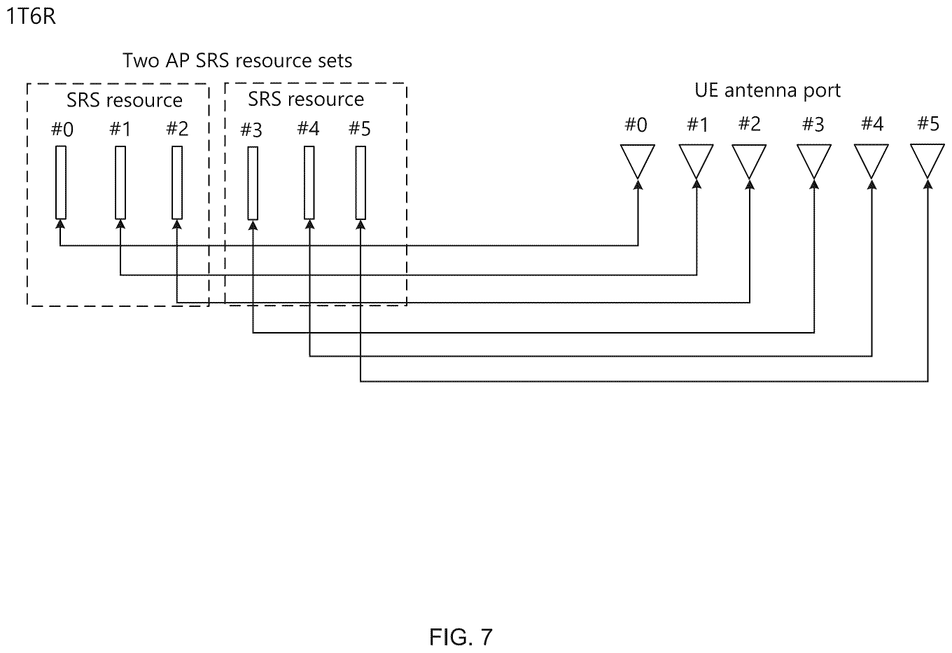

In a case of 1T6R, two AP SRS resource sets may include a total of six SRS resources and each SRS resource may include a single SRS port (FIG. 7), and the SRS ports of each SRS resource in the two resource sets are associated with the UE antenna ports different from each other. Note that the number of AP SRS resource sets may be three.

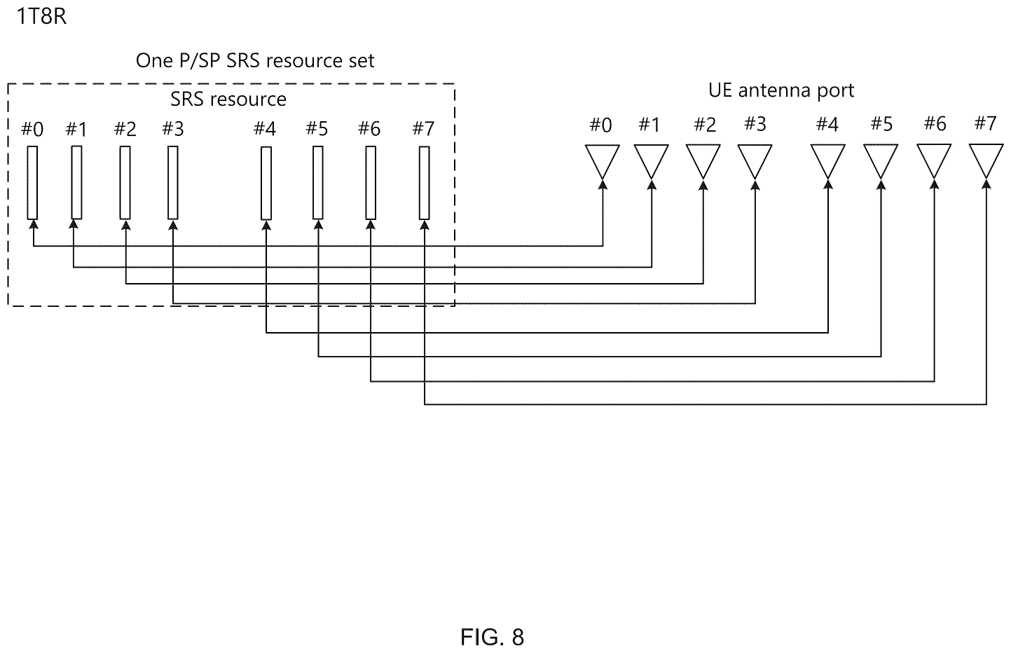

In a case of 1T8R, one P/SP SRS resource set may include eight SRS resources, and each SRS resource may include a single SRS port (FIG. 8). The SRS ports of different SRS resources in the SRS resource set are associated with different UE antenna ports.

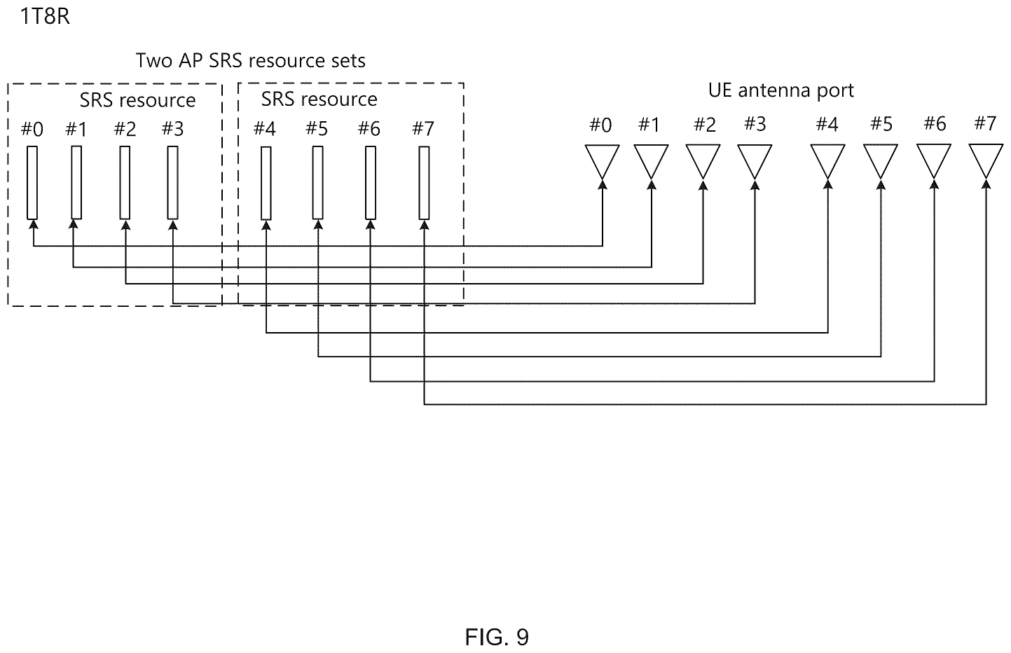

In a case of 1T8R, two AP SRS resource sets may include a total of eight SRS resources, and each SRS resource may include a single SRS port (FIG. 9). The SRS ports of the SRS resources in the two SRS resource sets are associated with the UE antenna ports different from each other. The number of AP SRS resource sets may be three or four.

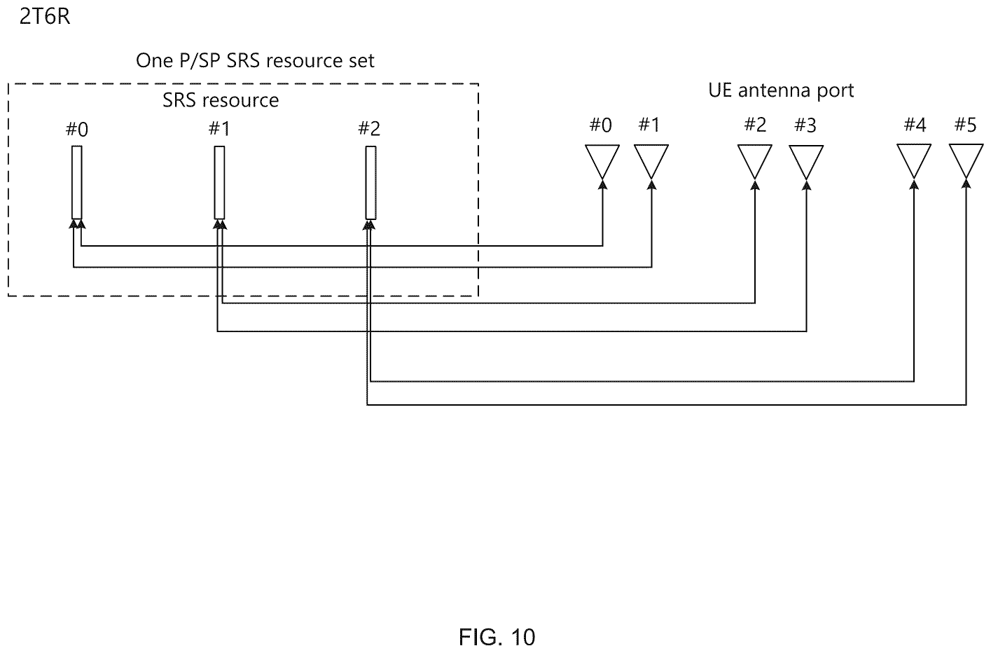

In a case of 2T6R, one P/SP SRS resource set may include three SRS resources, and each SRS resource may include two SRS ports (FIG. 10). The SRS port pairs of each SRS resource in the SRS resource set are associated with the UE antenna port pairs different from each other. In FIG. 10, UE antenna ports #0 and #1 are a pair, UE antenna ports #2 and #3 are a pair, and UE antenna ports #4 and #5 are a pair. The number of AP SRS resource sets may be two or three, and each SRS resource set may include one or two SRS resources.

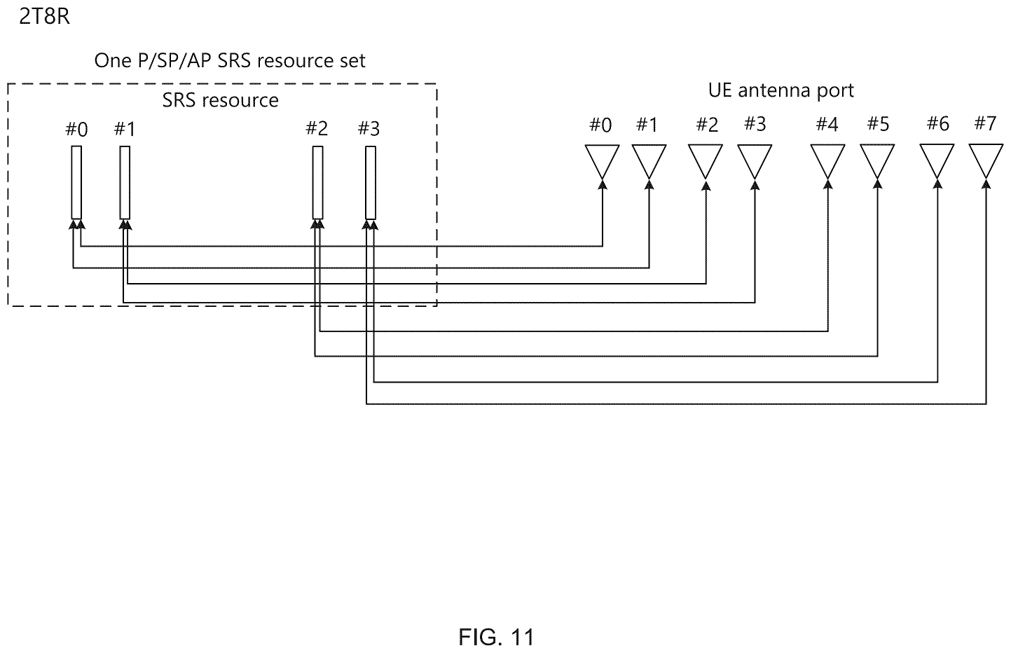

In a case of 2T8R, one P/SP/AP SRS resource set may include four SRS resources, and each SRS resource may include two SRS ports (FIG. 11). The SRS port pairs of each SRS resource in the SRS resource set are associated with the UE antenna port pairs different from each other. In FIG. 11, UE antenna ports #0 and #1 are a pair, UE antenna ports #2 and #3 are a pair, UE antenna ports #4 and #5 are a pair, and UE antenna ports #6 and #7 are a pair. The number of AP SRS resource sets may be two, three, or four, and each SRS resource set may include one, two, or three SRS resources.

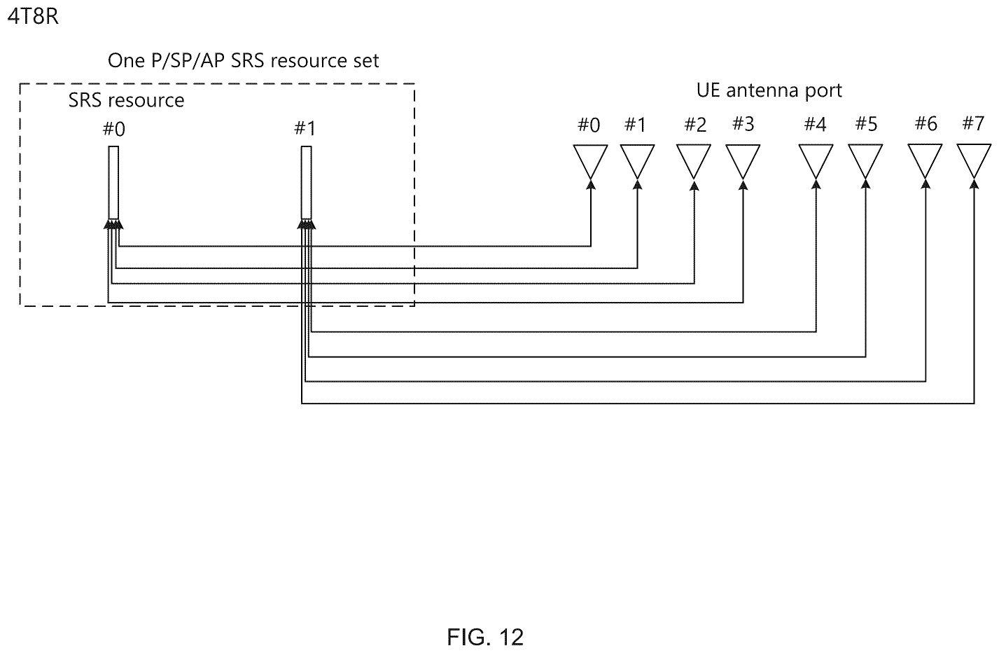

In a case of 4T8R, one P/SP/AP SRS resource set may include two SRS resources, and each SRS resource may include four SRS ports (FIG. 12). The SRS ports of each SRS resource in the SRS resource set are associated with the UE antenna ports different from each other. The number of AP SRS resource sets may be two, and each SRS resource set may include one SRS resource.

### Guard Period

A guard period of Y symbols is configured between the SRS resources in the SRS resource set. The UE does not transmit other signals while transmitting the SRS in the SRS resource set in the same slot.

When 1T2R, 1T4R, or 2T4R, or 1T6R, 1T8R, 2T6R, 2T8R, or 4T8R is applied, the UE does not expect that a plurality of SRS resource sets having the usage of the higher layer parameter being configured to “antennaSwitching” are configured or triggered in the same slot. When 1T=1R, 2T=2R, or 4T=4R is applied, the UE does not expect that a plurality of SRS resource sets having the usage of the higher layer parameter being configured to “antennaSwitching” are configured or triggered in the same symbol.

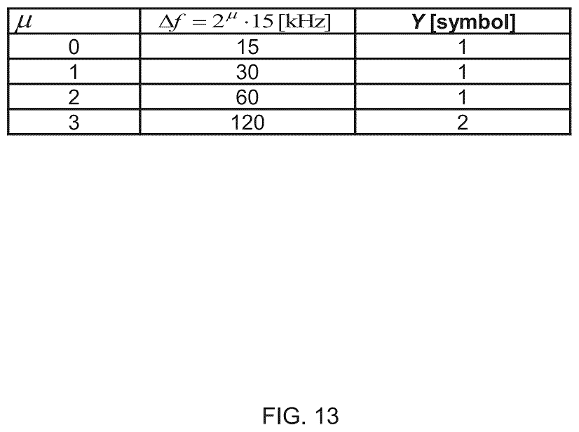

FIG. 13 is a diagram to show the guard period between two SRS resources when the usage is antenna switching in Rel. 15 and Rel. 16. FIG. 13 shows a relationship between the subcarrier spacing and the guard period (number of symbols).

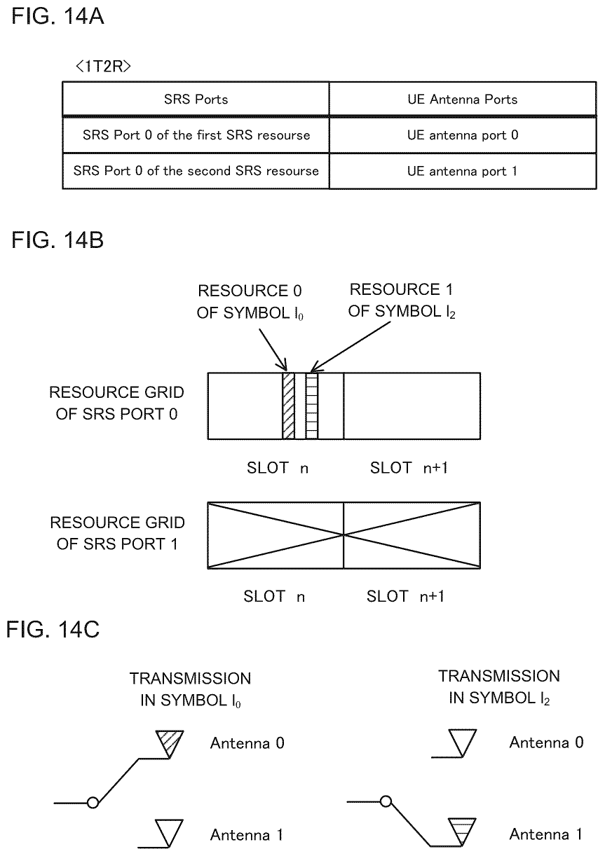

FIG. 14A is a diagram to show a relationship between the SRS ports and the UE antenna ports in 1T2R. In FIG. 14A, SRS port 0 of the first SRS resource and UE antenna port 0 are associated, and SRS port 0 of the second SRS resource and UE antenna port 1 are associated.

FIG. 14B is a diagram to show a resource grid of each SRS port in 1T2R. As shown in FIG. 14B, SRS port 0 is used for transmission of the SRS in resource 0 of symbol l₀ and resource 1 of symbol l₂. In this case, SRS port 1 is not used. A guard period is present between symbol l₀ and symbol l₂.

FIG. 14C is a diagram to show transmission states of the UE antenna ports in 1T2R. As shown in FIG. 14C, the UE transmits the SRS using UE antenna port 0 (Antenna 0) in symbol l₀, and transmits the SRS using UE antenna port 1 (Antenna 1) in symbol l₂. In other words, the UE switches the antenna port for transmitting the SRS from UE antenna port 0 to UE antenna port 1 after the guard period.

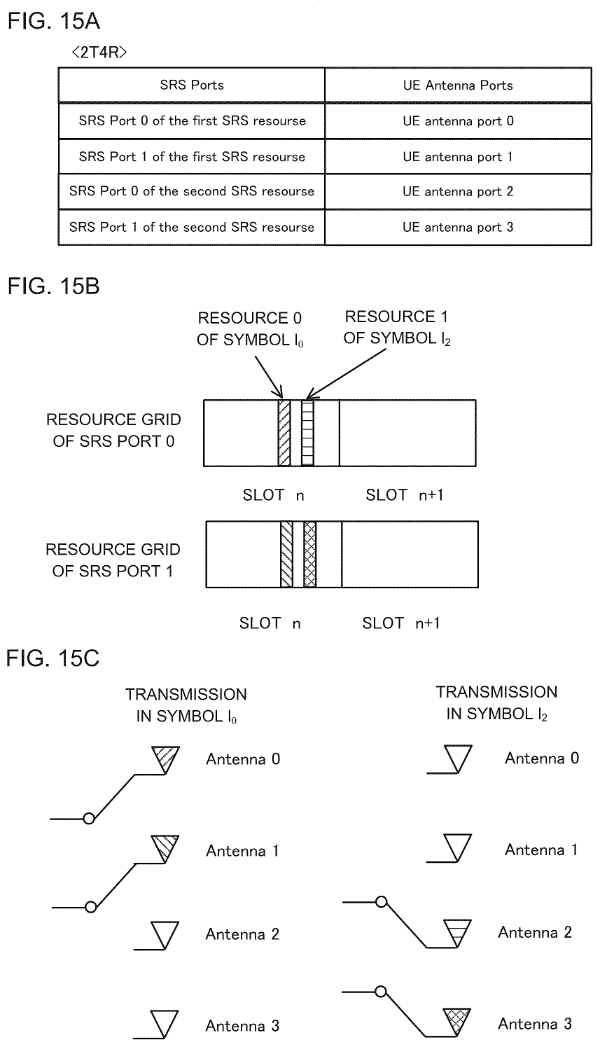

FIG. 15A is a diagram to show a relationship between the SRS ports and the UE antenna ports in 2T4R. In FIG. 15A, SRS port 0 of the first SRS resource and UE antenna port 0 are associated, and SRS port 1 of the first SRS resource and UE antenna port 1 are associated. SRS port 0 of the second SRS resource and UE antenna port 2 are associated, and SRS port 1 of the second SRS resource and UE antenna port 3 are associated.

FIG. 15B is a diagram to show a resource grid of each SRS port in 2T4R. As shown in FIG. 15B, SRS port 0 is used for transmission of the SRS in resource 0 of symbol l₀ and resource 1 of symbol l₂. The same holds true for SRS port 1. A guard period is present between symbol l₀ and symbol l₂.

FIG. 15C is a diagram to show transmission states of the UE antenna ports in 2T4R. As shown in FIG. 15C, the UE transmits the SRS using UE antenna port 0 (Antenna 0) and UE antenna port 1 (Antenna 1) in symbol l₀, and transmits the SRS using UE antenna port 2 (Antenna 2) and UE antenna port 3 (Antenna 3) in symbol l₂. In other words, the UE switches the antenna port for transmitting the SRS from UE antenna ports 0 and 1 to UE antenna ports 2 and 3 after the guard period.

### Analysis

In Rel-15 NR, as described above, antenna switching can be configured as the usage for the SRS. However, a configuration related to the SRS when antenna switching is configured as the usage for the SRS has not been fully studied. In this case, it is difficult for the UE to appropriately control SRS transmission, and thus communication throughput may be deteriorated.

For example, in future radio communication systems (Rel. 18), at least one of six transmission ports (6T)/eight transmission ports (ST) of the SRS may be applied. However, when 6T/8T is applied, whether an SRS configuration for antenna switching is supported or how the SRS configuration is supported has not been made clear. For example, it is considered that, when 6T is applied, the UE supports up to six layers for the UL, and when 8T is applied, the UE supports up to eight layers for the UL.

In view of this, the inventors of the present invention came up with the idea of a terminal that can receive an appropriate configuration when antenna switching is configured as the usage for the SRS.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be interchangeably interpreted. In the present disclosure, “A/B/C” may mean “at least one of A, B, and C”.

In the present disclosure, activate, deactivate, indicate, select, configure, update, determine, and the like may be interchangeably interpreted. In the present disclosure, “support,” “control,” “can control,” “operate,” “can operate,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

A spatial relation information Identifier (ID) (TCI state ID) and spatial relation information (TCI state) may be interchangeably interpreted. “Spatial relation information” may be interchangeably interpreted as “a set of spatial relation information”, “one or a plurality of pieces of spatial relation information”, and the like. The TCI state and the TCI may be interchangeably interpreted.

In the present disclosure, description of “Rel. XX” indicates a release of 3GPP. Note that release number “XX” is an example, and may be replaced with another number.

In the present disclosure, a P SRS and a P-SRS may be interchangeably interpreted. In the present disclosure, an SP SRS and an SP-SRS may be interchangeably interpreted. In the present disclosure, an AP SRS and an AP-SRS may be interchangeably interpreted. A resource set group and an SRS resource set group may be interchangeably interpreted.

In the present disclosure, application of xTyR, transmission (reporting) of “txry” in UE capability information (for example, supportedSRS-TxPortSwitch), and configuration of xTyR by higher layer signaling/physical layer signaling may be interchangeably interpreted. In the present disclosure, UL transmission with the number of layers greater than 4 may be applied. Processing of the present disclosure may be applied to the UE for which the number of layers greater than 4 is supported.

In the present disclosure, an SRS port, a transmission port, and an SRS transmission port may be interchangeably interpreted. In the present disclosure, a reception port, an antenna port, and a UE antenna port may be interchangeably interpreted.

### Radio Communication Method

When the UE receives a higher layer parameter indicating antenna switching as a usage of the SRS resource set and is configured with the usage, the UE may support/apply six or more SRS transmission ports and six or more antenna ports (for example, at least one of 6T6R, 6T8R, and 8T8R) according to the terminal (UE) capability information (for example, “supportedSRS-TxPortSwitch”) related to antenna switching. Note that each processing in the present disclosure may presuppose configuration of antenna switching as the usage of the SRS resource set (reception of the higher layer parameter indicating antenna switching as the usage of the SRS resource set).

As the UE capability information (for example, supportedSRS-TxPortSwitch) related to antenna switching, the UE may transmit (report) at least one of ‘t6r8’ corresponding to 618R, ‘t8r8’ corresponding to 8T8R, ‘t6r6-t6r8’ corresponding to 6T=6R/6T8R, ‘t6r8-t8x8’ corresponding to 6T8R/8T8R, and ‘t6r6-t8r8’ corresponding to 6T=6R/8T=8R. At least one of 6T8R, 6T6R, and 6T8R need not be supported.

UE capabilities related to combinations of the above new antenna switching (6T6R, 6T8R, and 8T8R) and existing xTyR may be supported. As the UE capabilities, at least two combinations out of {t1r1, t1r2, t1r4, t1r6, t1r8, t2r2, t2r4, t2r6, t2r8, t4r4, t4r8, t6r6, t6r8, t8r8} including new antenna switching and existing xTyR may be supported.

### Embodiment 1-1

Embodiment 1-1 will describe the SRS resource set configured with “periodic” or “semi-persistent” as a resource type of a corresponding RRC parameter “SRS-ResourceSet”, where six or more SRS ports and eight or more antenna ports (for example, 678R) are applied. The UE controls transmission of the SRS in the SRS resource set, using the six or more SRS ports and the eight or more antenna ports (for example, 6T8R).

### Aspect 1-1-1

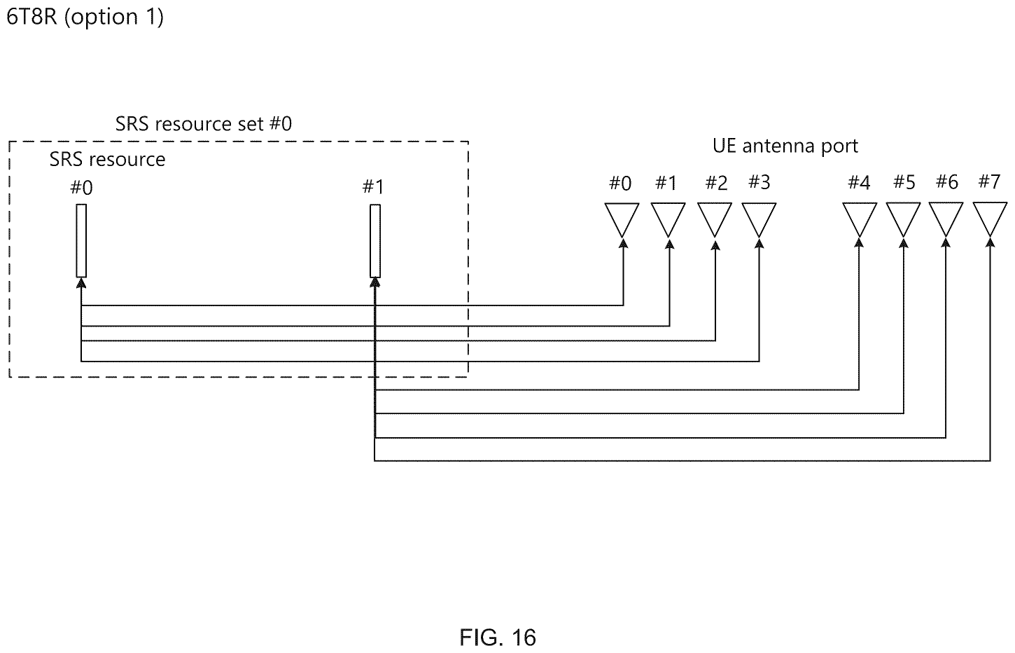

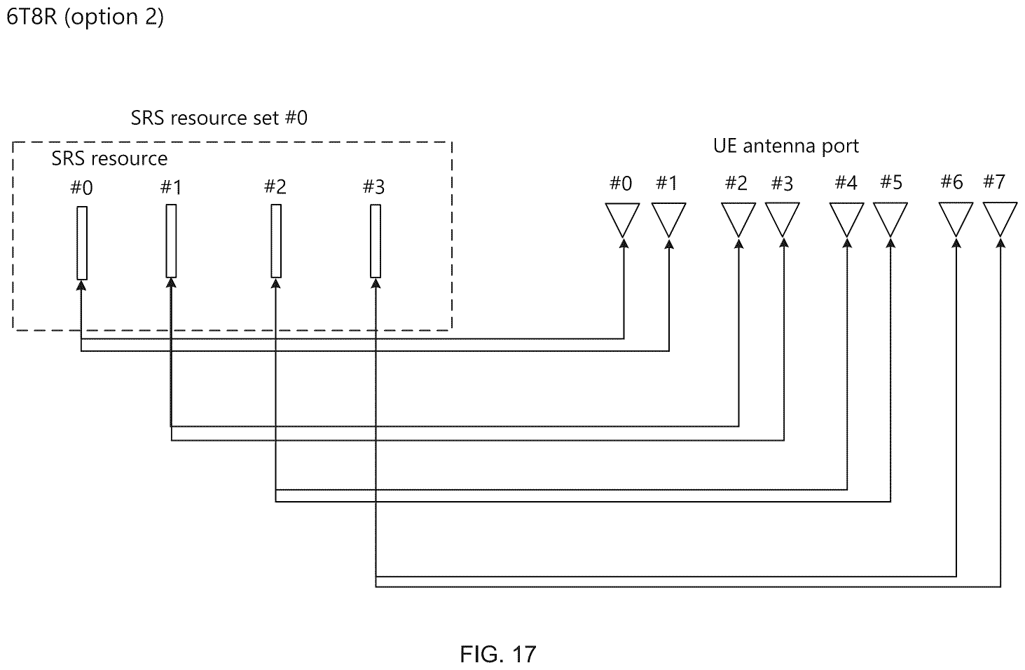

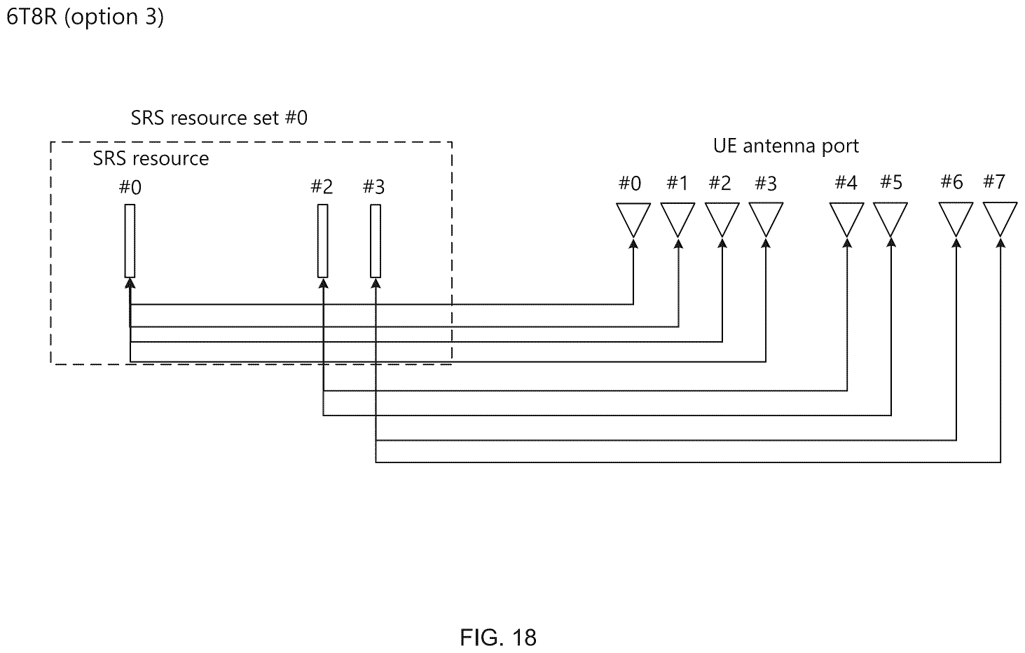

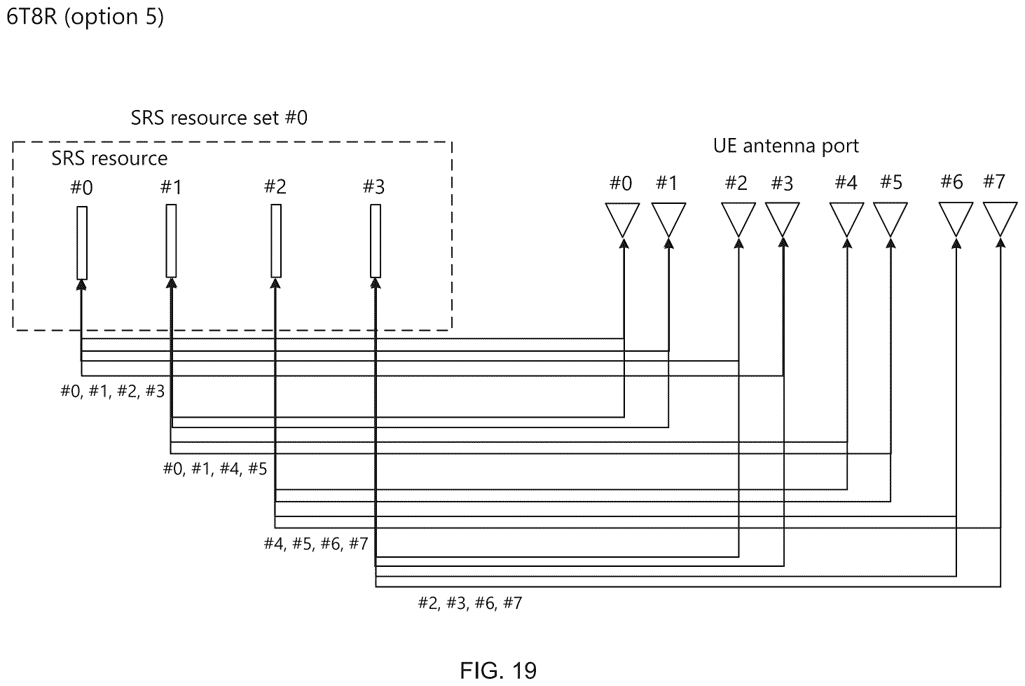

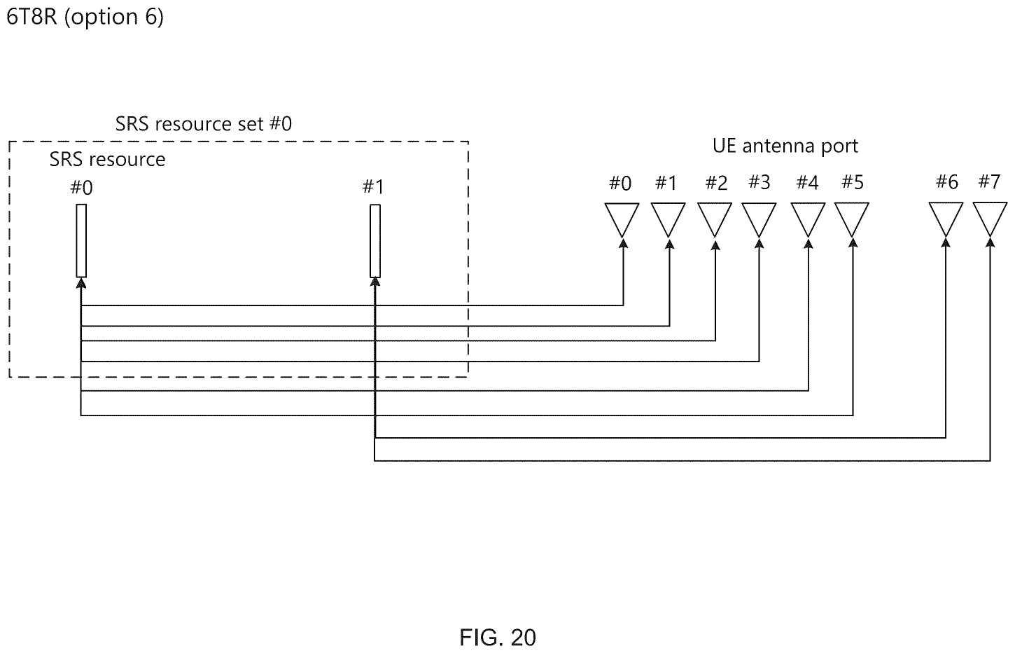

When 6T8R is applied, the UE may be configured with “periodic” as the resource type in the SRS resource set and configured with zero or one SRS resource set, using higher layer signaling, In this case, one of the following options may be applied.
[[Option 1]] One resource set includes two SRS resources to be transmitted in different symbols. Each SRS resource includes four SRS ports (FIG. 16).
[[Option 2]] One resource set includes four SRS resources to be transmitted in different symbols. Each SRS resource includes two SRS ports (FIG. 17).
[[Option 3]] One resource set includes three SRS resources to be transmitted in different symbols. One SRS resource includes four SRS ports, and the other two SRS resources each include two SRS ports (FIG. 18).
[[Option 4]] One resource set includes three SRS resources to be transmitted in different symbols. Each SRS resource includes four SRS ports.
[[Option 5]] One resource set includes four SRS resources to be transmitted in different symbols, and each SRS resource includes four SRS ports (FIG. 19). As shown in the example of FIG. 19, one UE antenna port may be associated with a plurality of SRS ports and measured twice.
[[Option 6]] One resource set includes two SRS resources to be transmitted in different symbols. One SRS resource includes six SRS ports, and the other one SRS resource includes two SRS ports (FIG. 20). When six SRS ports are supported/configured for antenna switching, the present option may be applied.
[[Option 7]] One resource set includes two SRS resources to be transmitted in different symbols. Each SRS resource includes six SRS ports. When six SRS ports are supported/configured for antenna switching, the present option may be applied.
[[Option 8]] One resource set includes two SRS resources to be transmitted in different symbols. One SRS resource includes six SRS ports, and the other one SRS resource includes four SRS ports. When six SRS ports are supported/configured for antenna switching, the present option may be applied.

When six SRS ports are not supported/configured for antenna switching, the UE may apply any one of options 1 to 5.

Regarding option 6/7/8, the UE may perform signaling/reporting of a new UE capability related to support of a 6-port SRS for antenna switching/non-codebook.

In 6T8R, when the UE does not indicate a specific UE capability corresponding to Rel. 17/18 (r17/r18), zero or one SRS resource set may be configured to “semi-persistent”. Alternatively, when the UE indicates a specific UE capability corresponding to Rel. 17/18, up to two SRS resource sets may be configured to semi-persistent, and up to one SRS resource set may be configured to “periodic”. Here, two SRS resource sets configured to semi-persistent are not simultaneously activated. As the number of SRS resources per resource set and the number of ports per SRS resource, any one of options 1 to 8 above may be applied.

### Aspect 1-1-2

In 6T8R, when the UE does not indicate a specific UE capability corresponding to Rel. 17/18 (r17/r18), different values (periodic or semi-persistent) may be configured as a value of the resource type of “SRS-ResourceSet” for zero, one, or two SRS resource sets. Alternatively, when the UE indicates a specific capability corresponding to Rel. 17/18 (r17/r18), up to two SRS resource sets may be configured to “semi-persistent”, and up to one SRS resource set may be configured to “periodic”. Here, two SRS resource sets configured to semi-persistent need not be simultaneously activated. As the number of SRS resources per resource set and the number of ports per SRS resource, any one of options 1 to 8 above may be applied.

The UE capability corresponding to Rel. 17/18 (r17/r18) may be a UE capability corresponding to Rel. 17 (a UE capability indicating support of up to two “semi-persistent” SRS resource sets and up to one “periodic” SRS resource set for antenna switching), or a UE capability corresponding to new Rel. 18 (for example, a maximum number of separate or joint SP/P/AP SRS resource sets).

The UE capability corresponding to Rel. 17 may be applied to all of xTyR with y being 8 or greater. When y of xTyR is greater than 4 and the UE capability corresponding to Rel. 17 is not supported, the UE may support up to one SRS resource set for the P-SRS and up to one SRS resource set for the SP-SRS. When y of xTyR is equal to or less than 4 and the UE capability corresponding to Rel. 17 is not supported, the UE may conform to the number (maximum number) of P-SRSs and SP-SRSs in Rel. 15. It may be defined that two SP-SRS resource sets are not simultaneously activated.

The SRS ports (pair) of the resources in one SRS resource set may be associated with different UE antenna ports (pair). The SRS ports (pair) of the SRS resources in different SRS resource sets are associated with different UE antenna ports (pair) in some options (option 1/2/3/6), and are associated with the same UE antenna ports (pair) in other options (option 4/5/7/8).

### Embodiment 1-2

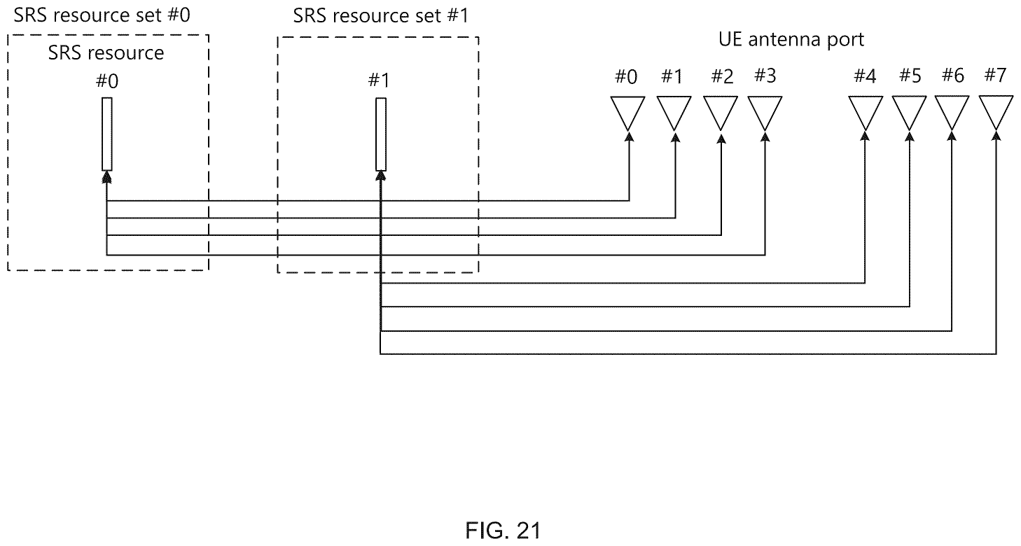

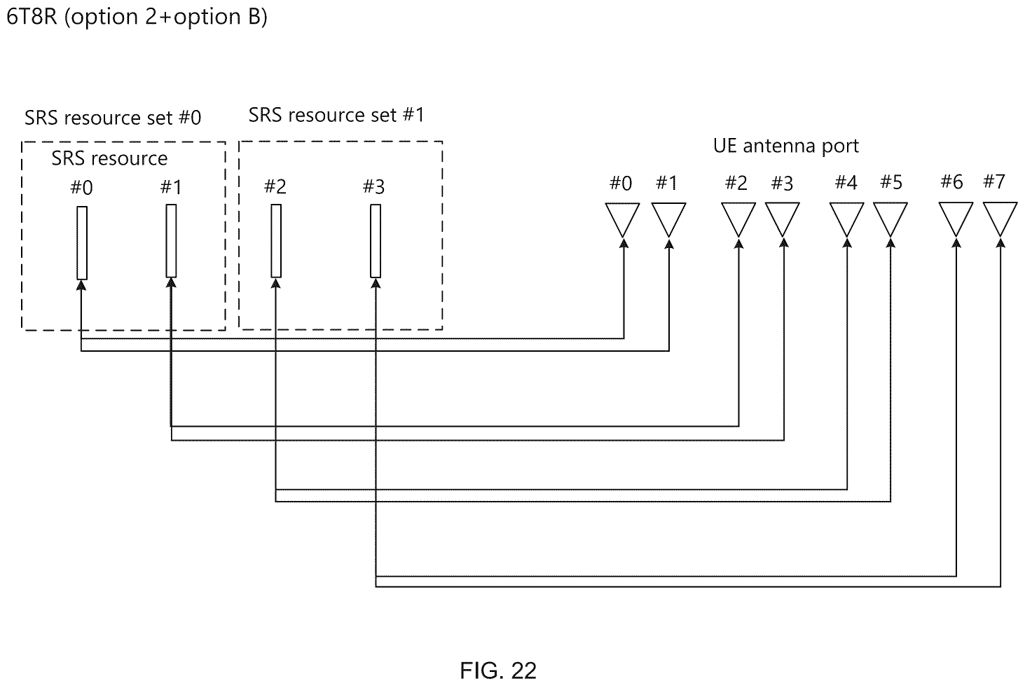

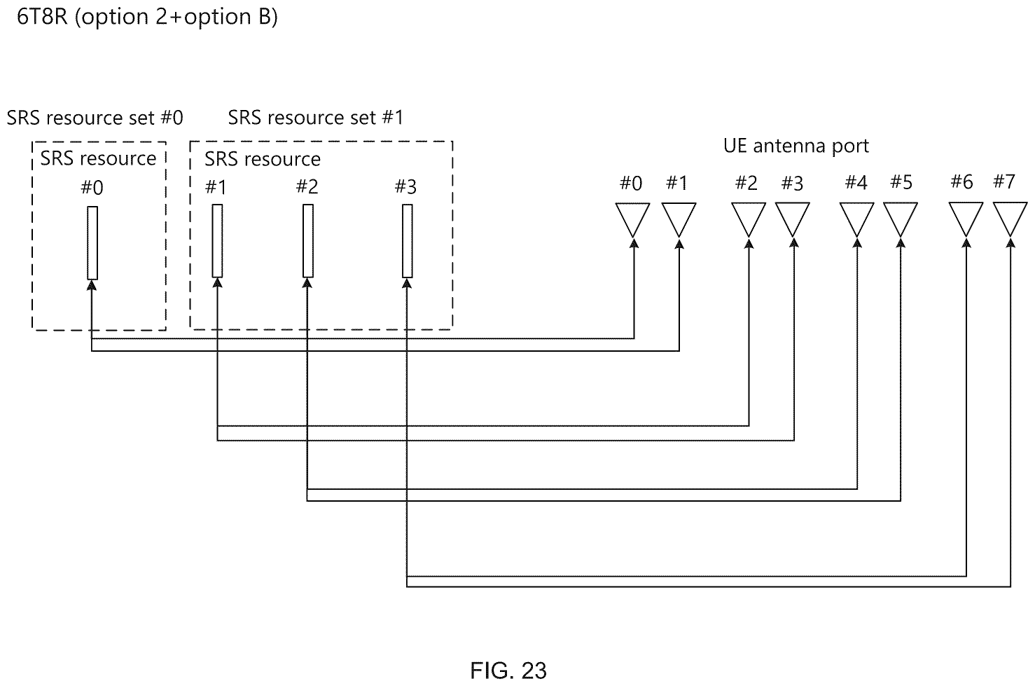

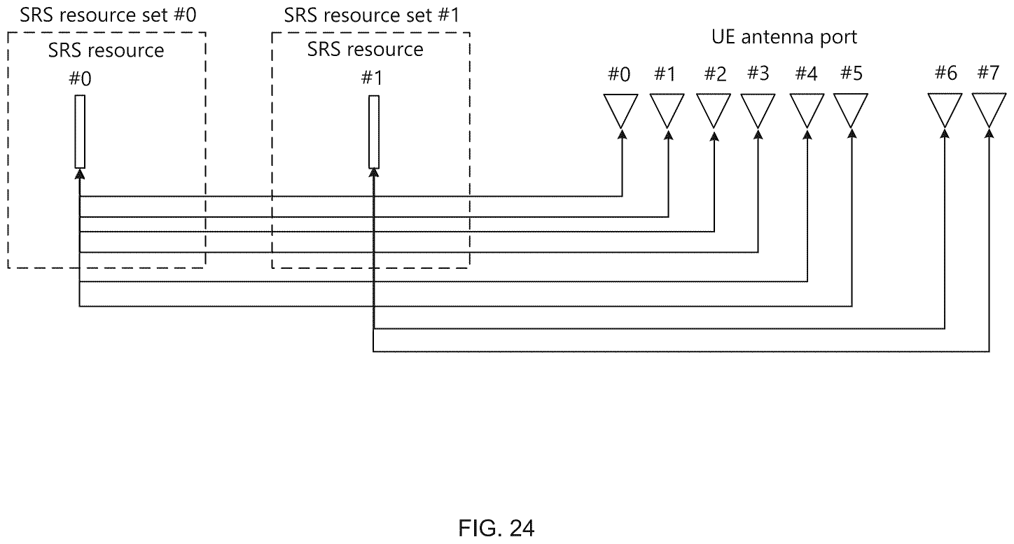

Embodiment 1-2 will describe the SRS resource set configured with “aperiodic” as a resource type of a corresponding RRC parameter “SRS-ResourceSet”, where six or more SRS ports and eight or more antenna ports (for example, 6T8R) are applied. The UE controls transmission of the SRS in the SRS resource set, using the six or more SRS ports and the eight or more antenna ports (for example, 6T8R). In this case, one of the following options may be applied.
[[Option 1]] One or more resource sets include a total of two SRS resources. Each SRS resource includes four SRS ports (FIG. 21).
[[Option 2]] One or more resource sets include a total of four SRS resources. Each SRS resource includes two SRS ports (FIGS. 22 and 23). For example, each SRS resource set may include two SRS resources (FIG. 22). Alternatively, a first SRS resource set may include one SRS resource, and a second SRS resource set may include three SRS resources (FIG. 23).
[[Option 3]] One or more resource sets include a total of three SRS resources. One SRS resource includes four SRS ports. The other two SRS resources each include two SRS ports.
[[Option 4]] One or more resource sets include a total of three SRS resources, Each SRS resource includes four SRS ports.
[[Option 5]] One or more resource sets include a total of four SRS resources. Each SRS resource includes four SRS ports.
[[Option 6]] One or more resource sets include two SRS resources. One SRS resource includes six SRS ports, and the other one SRS resource includes two SRS ports (FIG. 24). When six SRS ports are supported/configured in antenna switching, the present option may be applied.
[[Option 7]] One or more resource sets include two SRS resources. Each SRS resource includes six SRS ports. When six SRS ports are supported/configured in antenna switching, the present option may be applied.
[[Option 8]] One or more resource sets include two SRS resources. One SRS resource includes six SRS ports, and one SRS resource includes four SRS ports. When six SRS ports are supported/configured in antenna switching, the present option may be applied.

When six SRS ports are not supported/configured for antenna switching, the UE may apply any one of options 1 to 5.

Regarding option 6/7/8, the UE may perform signaling/reporting of a new UE capability related to support of a 6-port SRS for antenna switching/non-codebook.

Regarding the number of SRS resource sets, any one of the following options A to D may be applied. The number of SRS resource sets and the number of SRS resources included in each SRS resource set may be configured using higher layer signaling/physical layer signaling, or may be defined in a specification.
[[Option A]] (Corresponding to option 1/6/7/8) Zero to two SRS resource sets are applied. FIGS. 21 and 24 show examples of two SRS resource sets.
[[Option B]] (Corresponding to option 2/5) Zero to four SRS resource sets are applied. When two SRS resource sets are applied, each SRS resource set may include two SRS resources (FIG. 22). When two SRS resource sets are applied, one SRS resource set may include one SRS resource, and the other one SRS resource set may include three SRS resources (FIG. 23).

When three SRS resource sets are applied, one (first) SRS resource set may include one SRS resource, another (second) SRS resource set may include one SRS resource, and another (third) SRS resource set may include two SRS resources.
[[Option C]] (Corresponding to option 3) Zero to three SRS resource sets are applied. When two SRS resource sets are applied, one SRS resource set may include one SRS resource including four SRS ports, and the other one SRS resource set may include two SRS resources each including two SRS ports. When two SRS resource sets are applied, one SRS resource set may include one SRS resource including two SRS ports and one SRS resource including four SRS ports, and the other one SRS resource set may include the rest of SRS resources including two SRS ports.
[[Option D]] (Corresponding to option 4) Zero to three SRS resource sets are applied. When two SRS resource sets are applied, one SRS resource set may include two SRS resources, and the other one SRS resource set may include one SRS resource.

In options A to D, X SRS resource sets are present, and when X is equal to the number of SRS resources, the SRS resource sets may each include one SRS resource. In each option, which SRS resource is included in which SRS resource set may be configured using higher layer signaling/physical layer signaling. When Y resource sets are applied, the UE may transmit X SRS resources in different symbols in Y different slots. The UE may be capable of transmitting (reporting) a new UE capability (for example, Cap-AP-r18) related to the maximum number of SRS resource sets configured with “aperiodic” of certain xTyR.

According to the present embodiment, configurations of the SRS resource sets, the SRS resources, and the SRS ports when 6T8R is applied are clarified, and the UE can perform appropriate SRS transmission by receiving these configurations.

### Embodiment 2

Embodiment 2 will describe an example in which the UE does not support (does not indicate) a specific UE (terminal) capability (for example, capability information (r17/r18) corresponding to Rel. 17/18), where 6T6R or 8T8R is applied. When the UE does not support the specific terminal capability, the UE may control transmission of the SRS, using six or more SRS ports (for example, 6T6R or 8T8R), of which number is equal to the number of antenna ports. In this case, one of the following options may be applied.
[[Option 1]] Zero to two SRS resource sets each including one SRS resource are applied. The number of SRS ports of each SRS resource is 1, 2, or 4.
[[Option 2]] Zero to three SRS resource sets each including one SRS resource are applied. The number of SRS ports of each SRS resource is 1, 2, or 4.
[[Option 3]] Zero to four SRS resource sets each including one SRS resource are applied. The number of SRS ports of each SRS resource is 1, 2, or 4.
[[Option 4]] Zero to two SRS resource sets each including two SRS resources are applied. The number of SRS ports of each SRS resource is 1, 2, or 4.
[[Option 5]] Zero or one SRS resource set each including two SRS resources are applied. The number of SRS ports of each SRS resource is 1, 2, or 4.
[[Option 6]] Zero to two SRS resource sets each including four SRS resources are applied. The number of SRS ports of each SRS resource is 1, 2, or 4.
[[Option 7]] Zero or one SRS resource set each including four SRS resources are applied. The number of SRS ports of each SRS resource is 1, 2, or 4.
[[Option 8]] When a 6-port SRS is supported/configured for antenna switching, or signaling/reporting of a new UE capability related to support of six SRS ports for antenna switching/non-codebook is performed, one SRS resource may include six SRS ports. Option 8 may be combined with any one of options 1 to 7.
[[Option 9]] When eight SRS ports are supported/configured for antenna switching, or signaling/reporting of a new UE capability related to support of eight SRS ports for antenna switching/non-codebook is performed, one SRS resource may include eight SRS ports. Option 9 may be combined with any one of options 1 to 7.

Two or more SRS resource sets may be applied only to “aperiodic”. The UE may transmit (report) a new UE capability (for example, Cap-AP-r18) related to the maximum number of SRS resource sets, which is configured with “aperiodic” or for antenna switching having a specific port SRS (for example, for a 6-port or 8-port SRS).

When the UE indicates a new specific UE capability (cap_r17/r18), up to two SRS resource sets having resourceType of the RRC parameter SRS-ResourceSet being configured to “semi-persistent” and up to one SRS resource set having resourceType of SRS-ResourceSet being configured to “periodic” may be configured. Here, two SRS resource sets configured with “semi-persistent” need not be simultaneously activated.

According to the present embodiment, configurations of the SRS resource sets, the SRS resources, and the SRS ports when 6T6R and 8T8R are applied are clarified, and the UE can perform appropriate SRS transmission by receiving these configurations.

### Embodiment 3

When 6T8R is applied, the UE does not expect (assume) (is not configured/triggered) that more than one SRS resource set having the usage of the higher layer parameter being configured to antenna switching is configured/triggered in the same slot.

When 6T=6R or 8T=8R is applied, the UE does not expect (assume) (is not configured/triggered) that more than one SRS resource set having the usage of the higher layer parameter being configured to antenna switching is configured/triggered in the same symbol.

### Additional Notes

As described above, when 6T/8T is applied to the SRS ports, six ports/eight ports may be applied to the CB (codebook) PUSCH.

When six/eight SRS ports for antenna switching are not supported, the UE may be configured with one/two/four SRS ports for antenna switching and perform DL CSI measurement/reporting for the UE for 6T/8T (for example, options 1 to 5 of Embodiment 1-1 and Embodiment 1-2, options 1 to 7 of Embodiment 2).

### UE Capability

The UE may transmit (report) UE capability information indicating whether to support at least one of the examples in the present disclosure to a network (base station). The UE may receive an indication/configuration related to at least one of the examples in the present disclosure (for example, an indication/configuration related to enabling/disabling), using higher layer signaling/physical layer signaling. The indication/configuration may correspond to the UE capability information that has been transmitted by the UE. At least one of the examples in the present disclosure may be applied only to the UE that has received the indication/configuration, the UE that has transmitted corresponding UE capability information, or the UE that supports a corresponding UE capability.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

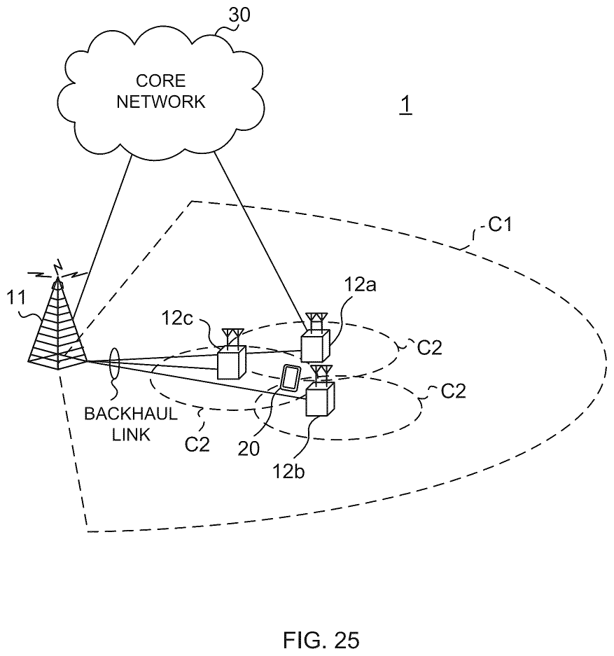

FIG. 25 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 Ghz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, and 5G.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces, The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may also be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

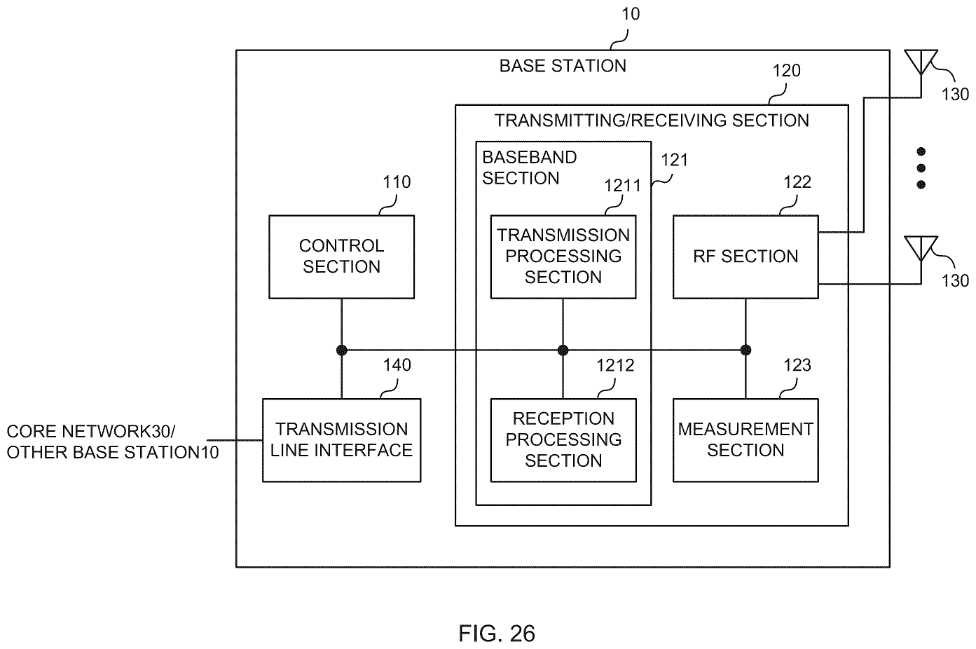

FIG. 26 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

Note that the transmitting/receiving section 120 may transmit a higher layer parameter indicating antenna switching as a usage for a sounding reference signal (SRS) resource set. The transmitting/receiving section 120 may receive an SRS transmitted using six or more SRS ports and six or more antenna ports, the six or more SRS ports and the six or more antenna ports being applied in a terminal according to terminal capability information related to the antenna switching. The control section 110 may control transmission and reception of the transmitting/receiving section 120.

### User Terminal

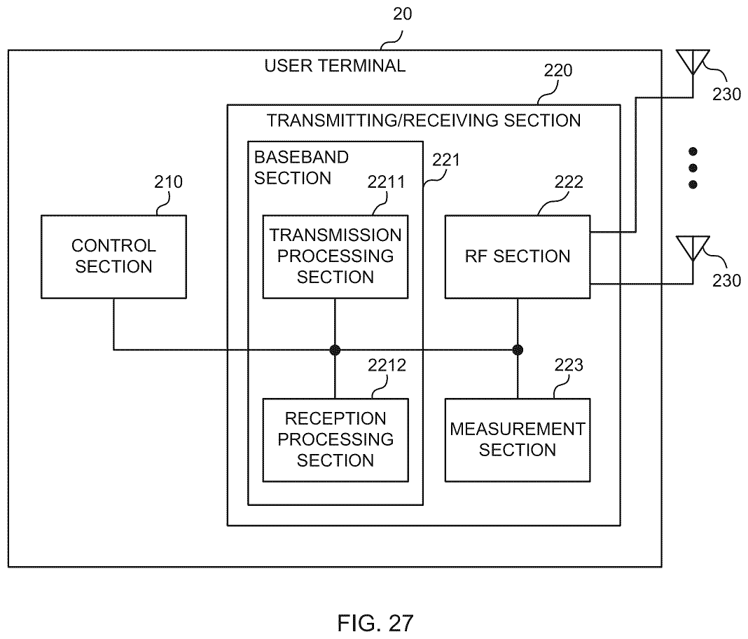

FIG. 27 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DET processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-S-OFDM waveform if transform precoding is enabled, and otherwise, does not need to perform the DET processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RE section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may receive a higher layer parameter indicating antenna switching as a usage for a sounding reference signal (SRS) resource set.

The control section 210 may apply six or more SRS ports and six or more antenna ports according to terminal capability information related to the antenna switching.

The control section 210 may control transmission of an SRS in the SRS resource set configured with periodic or semi-persistent as a resource type, using the six or more SRS ports and the eight or more antenna ports.

The control section 210 may control transmission of an SRS in the SRS resource set configured with aperiodic as a resource type, using the six or more SRS ports and the eight or more antenna ports.

When the control section 210 does not support a specific terminal capability, the control section 210 may control transmission of an SRS, using the six or more SRS ports, of which number is equal to the number of the antenna ports.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

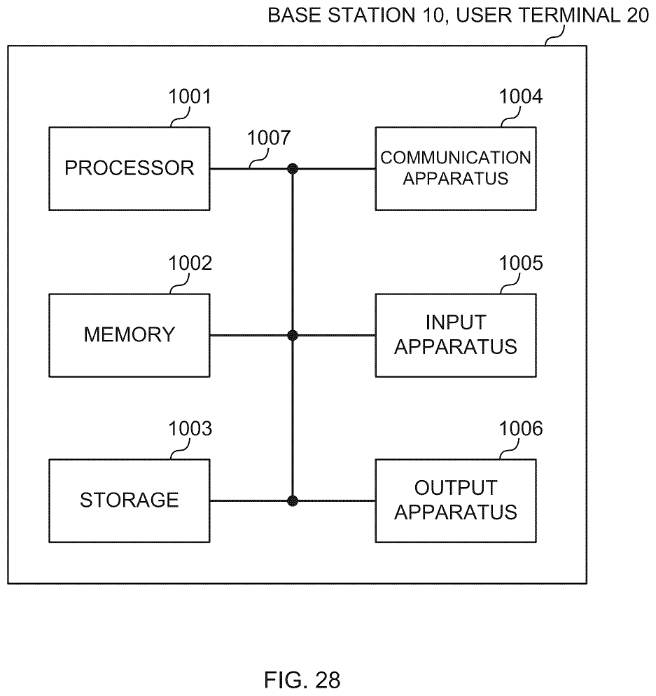

For example, a base station, a user terminal, and so on according to one embodiment of the present disclosure may function as a computer that executes the processes of the radio communication method of the present disclosure. FIG. 28 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be indicated by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is an object which can move with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an autonomous car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

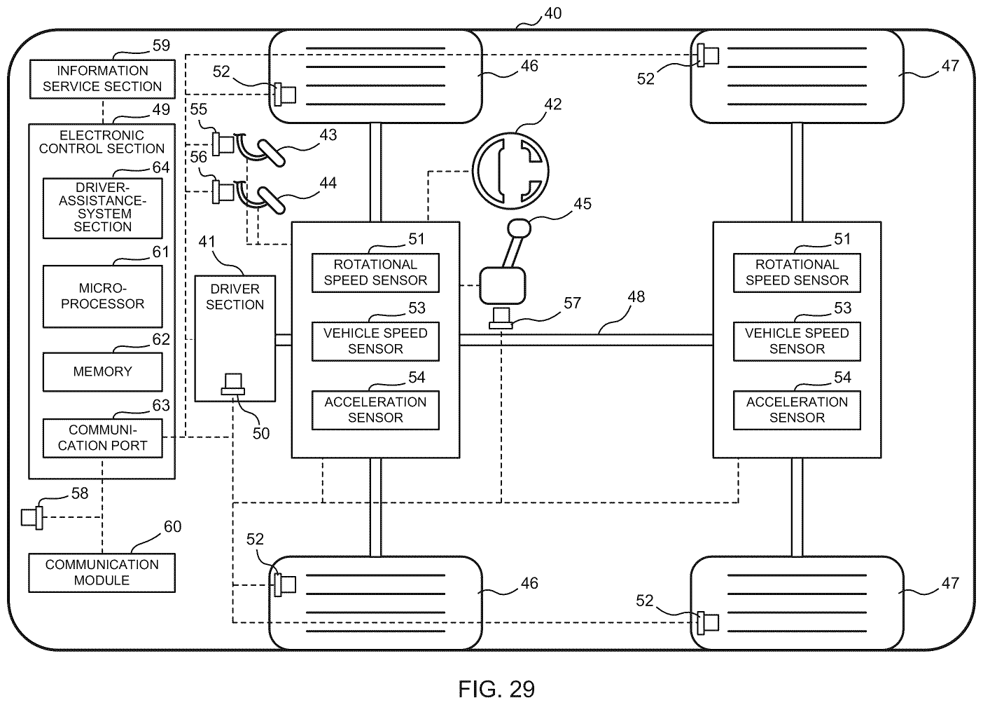

FIG. 29 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The drive section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driver-assistance-system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driver-assistance-system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the drive section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the drive section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1.-6. (canceled)

7. A terminal comprising:
a receiver that receives a higher layer parameter indicating antenna switching as a usage of a sounding reference signal (SRS) resource set; and
a processor that controls, according to terminal capability information supporting 8 SRS ports and 8 reception ports for the antenna switching, a transmission of an SRS using the 8 SRS ports and the 8 reception ports.

8. The terminal according to claim 7, wherein the processor controls the transmission of the SRS in up to two SRS resource sets configured with ‘semi-persistent’ as a resource type of the SRS resource set and up to one SRS resource set configured with ‘periodic’ as the resource type.

9. The terminal according to claim 8, wherein two SRS resource sets configured with ‘semi-persistent’ as the resource type are not simultaneously activated.

10. The terminal according to claim 7, wherein up to two of the SRS resource sets are configured, each SRS resource set having one SRS resource, a number of SRS ports for each SRS resource being 1, 2, 4, or 8.

11. The terminal according to claim 7, wherein the terminal capability information indicates that less than 8 SRS ports and less than 8 reception ports are also supported.

12. A radio communication method for a terminal, comprising:
receiving a higher layer parameter indicating antenna switching as a usage of a sounding reference signal (SRS) resource set; and
controlling, according to terminal capability information supporting 8 SRS ports and 8 reception ports for the antenna switching, a transmission of an SRS using the 8 SRS ports and the 8 reception ports.

13. A base station comprising:
a transmitter that transmits, to a terminal, a higher layer parameter indicating antenna switching as a usage of a sounding reference signal (SRS) resource set; and
a processor that controls, according to terminal capability information supporting 8 SRS ports and 8 reception ports for the antenna switching, a reception of an SRS that is transmitted using the 8 SRS ports and the 8 reception ports by the terminal.

14. A system comprising a terminal and a base station, wherein
the terminal comprises:
a receiver that receives a higher layer parameter indicating antenna switching as a usage of a sounding reference signal (SRS) resource set; and
a processor that controls, according to terminal capability information supporting 8 SRS ports and 8 reception ports for the antenna switching, a transmission of an SRS using the 8 SRS ports and the 8 reception ports, and
the base station comprises:
a transmitter that transmits the higher layer parameter to the terminal; and
a processor that controls a reception of the SRS.
